(19) United States
(12) Patent Application Publication
(10) Pub. No.: US 2009/0016562 A1
(43) Pub. Date: Jan. 15, 2009

(54) Loudspeaker

(76) Inventor: Ko Fe Hsiao, Taipei County (TW)

Correspondence Address: BIRCH STEWART KOLASCH & BIRCH, PO BOX 747, FALLS CHURCH, VA, 22040-0747, US

(21) Appl. No.: 11/822,619

(22) Filed: Jul. 9, 2007

(51) Int. Cl. H04R 9/06

(52) U.S. Cl. 381/423

(57) ABSTRACT

A loudspeaker containing an improved voice drive structure including a convex diaphragm adhered with a voice coil before being mounted to a modified damper integrated with a surround to increase directivity of output of sound effects and effective expand sound field of the loudspeaker.

### FIELD OF THE INVENTION

The present invention is related to a loudspeaker, and more particularly, to an improved structure of voice drive materials of the loudspeaker.

### BACKGROUND OF THE INVENTION

Whereas an electrodynamics loudspeaker of the prior art is essentially of magnetic circuit materials including magnet, U-shaped iron (yoke), washer, and frame; and moving system including damper, cone-paper (cone and surround), voice coil, and dust cap. According to an equation of force, F-BLI, wherein B relates to density of magnetic flux in a magnetic gap; L, length of voice coil conductor; and I, electric current flowing through voice coil, a working principle of the loudspeaker involves an electromagnetic force F that varies when both of strength and direction of electric current flowing through the coil voice change for the voice coil to vibrate back and forth thus to drive the cone-paper to propel the air, and the air in turn serving as a medium to radiate sound waves.

Referring to FIG. 1 for a schematic view of a loudspeaker of the prior art, a magnetic circuit including a frame of basket 1, and a U-shaped iron (yoke) 2 containing a magnet 3 and a washer 4 disposed beneath the frame of basket 1 is assembled first, and then moving system including a damper 5, a voice coil 6, a cone-paper 7, and a dust cap 8 are glued to the frame of basket 1.

In the prior art, the output of sound is achieved by relying upon the cone-paper and the dust cap 8 to drive the air; however, the prior art is found with a major flaw in meeting requirements of certain sound field because that the conventional cone-paper has a poor directivity property.

### SUMMARY OF THE INVENTION

The primary purpose of the present invention is to provide an improved structure of voice drive materials in a loudspeaker that is capable of increasing directivity of sound effects, expanding sound field, and allowing flatter and thinner construction of the entire loudspeaker through mounting a convex diaphragm glued with a voice coil to a modified damper (integrated damper and surround).

### BRIEF DESCRIPTION OF THE DRAWINGS

FIG. 1 is a schematic view showing a loudspeaker of the prior art.

FIG. 2 is a sectional view showing an improved structure of voice drive material of a loudspeaker of the present invention.

FIG. 3 is a schematic view showing a circular diaphragm and an oval diaphragm of the present invention.

FIG. 4 is a schematic view showing two modified dampers of the present invention respectively provided in a circular and an oval forms.

FIG. 5 is a schematic view showing a preferred embodiment of the present invention.

FIG. 6 is a schematic view showing another preferred embodiment of the present invention.

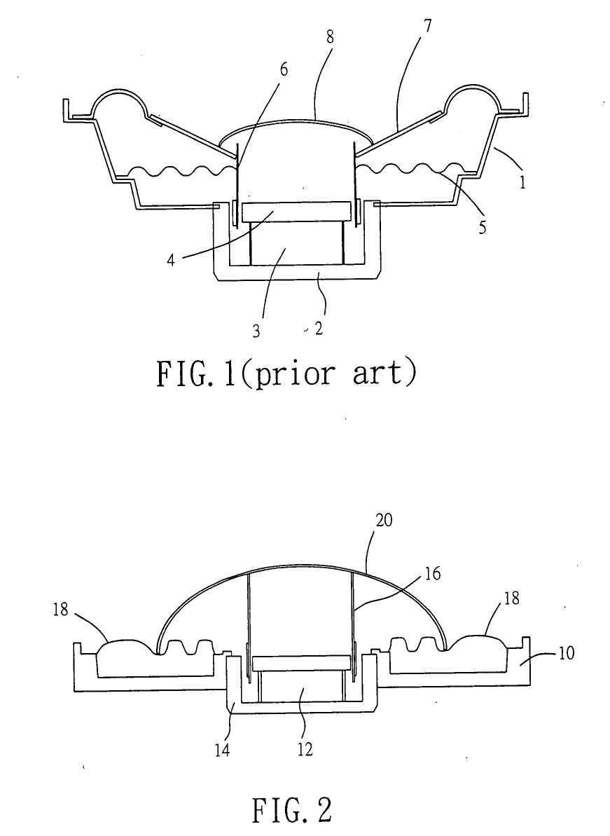

### DETAILED DESCRIPTION OF THE PREFERRED EMBODIMENTS

Referring to FIG. 2 for a sectional view of an improved structure of a loudspeaker of the present invention, a frame of basket 10 containing at its center a magnet 12 and enclosed by a U-shape iron (yoke) 14. Wherein the frame of basket 10, the magnet 12, and the U-shape iron (yoke) 14 are referred to magnetic circuit materials. A modified damper 18 (an integrated part of the damper and a surround) is adhered to where inside the frame of basket 10, and a convex diaphragm 20 adhered to a voice coil 16 is mounted to where above the modified damper 18 (damper+surround). Wherein, the voice coil 16, the modified damper 18 (damper+surround) and the convex diaphragm 20 are referred to voice drive materials. Accordingly, with the improved structure, the loudspeaker of the present invention is generally reduced in thickness and provided with expanded directivity.

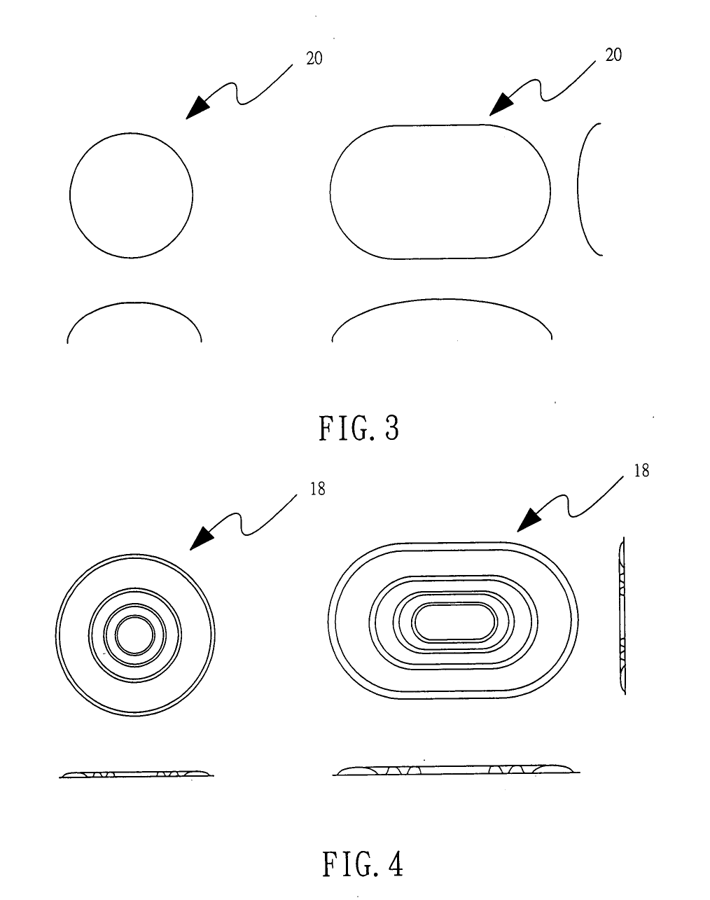

Now referring to FIG. 3 for an oval and a circular diaphragm of the present invention, the diaphragm 20 is made in an over, circular, or rectangular (not illustrated) shape to cope with changed style of a speaker system.

As illustrated in FIG. 4, the modified damper 18 may be made in an oval, circular, or rectangular (not illustrated) shape to cope with changed style of a speaker system.

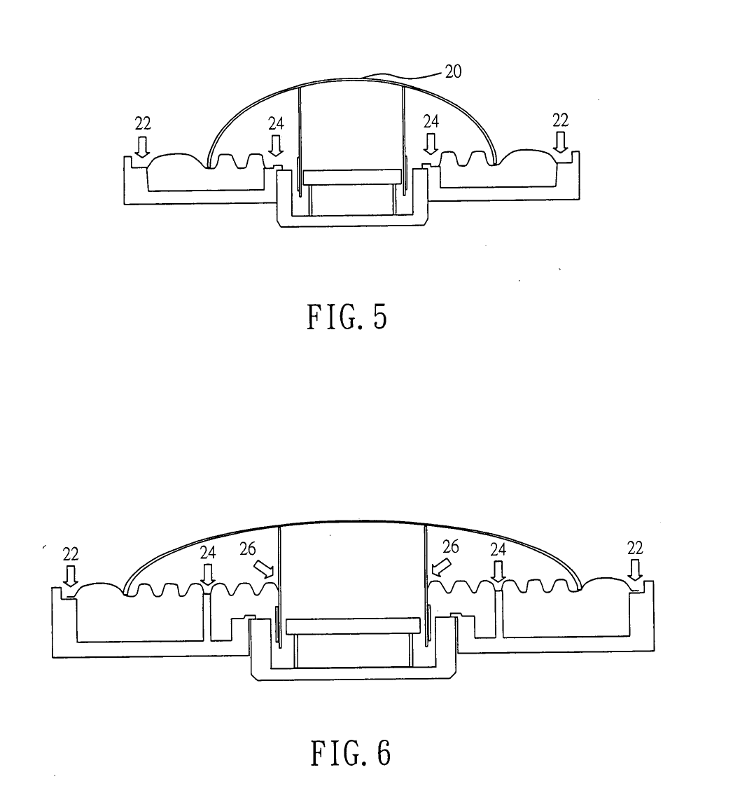

In a preferred embodiment of the loudspeaker of the present invention as illustrated in FIG. 5, the modified damper 18 has its both ends as two adhesion locations 22, 24 to be adhered to where inside the frame of basket 10 before mounting the diaphragm 20 already adhered with the voice coil 16 to the modified damper 18 for achieving the purpose of supporting those voice drive materials.

In another preferred embodiment as illustrated in FIG. 6, the modified damper 18 is adhered to the frame of basket 10 by means of three adhesion locations 22, 24, 26 before mounting the convex diaphragm 20 already adhered with the voice coil 16 to the modified damper 18 to achieve the same purpose of supporting those voice drive materials.

The modified damper 18 may be made of a single type of material (e.g., fabric, jute, plastic, etc.), or a combination of different materials to attain various properties, e.g., consistence, softness, and suitability.

What is claimed is:

1. An improved structure of a loudspeaker comprising loudspeaker provided with a voice drive assembly containing a modified damper; the modified damper being made in an integral part with a surround; the modified damper being mounted inside a frame of basket; and a convex diaphragm being adhered with a voice coil being mounted over the modified damper.

2. The improved structure of a loudspeaker as claimed in claim 1, wherein the convex diaphragm contains the voice coil.

3. The improved structure of a loudspeaker as claimed in claim 1, wherein both of the modified damper and the convex diaphragm are each made in a circular form.

4. The improved structure of a loudspeaker as claimed in claim 1, wherein both of the modified damper and the convex diaphragm are each made in an oval form.

5. The improved structure of a loudspeaker as claimed in claim 1, wherein both of the modified damper and the convex diaphragm are each made in a rectangular form.

6. The improved structure of a loudspeaker as claimed in claim 1, wherein the modified damper is made in an integral part of a same type of material.

7. The improved structure of a loudspeaker as claimed in claim 1, wherein the modified damper is made of two different types of materials.

8. The improved structure of a loudspeaker as claimed in claim 1, wherein the modified damper is incorporated to where inside the frame of basket with both ends of the modified damper.

9. The improved structure of a loudspeaker as claimed in claim 1, wherein the modified damper is incorporated to where inside the frame of basket and to the voice coil by means of multiple ends of the modified damper.
